(19) United States
(12) Patent Application Publication
(10) Pub. No.: US 2011/0114542 A1
(43) Pub. Date: May 19, 2011

(54) VIBRATORY SEPARATOR MOTION

(75) Inventors: Brian S. Carr, Burlington, KY (US); Michael A. Timmerman, Cincinnati, OH (US); Benjamin L. Holton, Dayton, KY (US)

(73) Assignee: M-I L.L.C., Houston, TX (US)

(21) Appl. No.: 12/988,719

(22) PCT Filed: Apr. 22, 2009
(86) PCT No.: PCT/US2009/041438

§ 371 Date: Jan. 7, 2011

Related U.S. Application Data
(60) Provisional application No. 61/047,039, filed on Apr. 22, 2008.

(51) Int. Cl. B07B 1/42; E21B 21/06

(52) U.S. Cl. 209/235; 209/369

(57) ABSTRACT

A vibratory separator (100) including a first actuator (107A) coupled to a basket (105) and a second actuator (107B) coupled to the basket. Additionally, the vibratory separator (100) includes a motion control switch operatively connected to at least one of the first and second actuators (107A, 107B) and configured to modulate motion generated by the first and second actuators between a first elliptical motion and a second elliptical motion. Also, a method of processing drilling waste, the method including flowing drilling waste over a screen of a vibratory separator and imparting a first elliptical motion to the screen. The method further includes monitoring the flow of drilling waste over the screen, determining an overload condition exists, and adjusting the motion to a second elliptical motion based on the determined load condition.

### BACKGROUND

1. Field of the Disclosure

Embodiments disclosed herein relate generally to apparatuses and methods for separating solids from liquids. Specifically, embodiments disclosed herein relate to apparatuses and methods for separating solids from liquids using dual motion profiles on vibratory separators. More specifically still, embodiments disclosed herein relate to apparatuses and methods for producing a first elliptical motion and a second elliptical motion on vibratory separators.

Background Art

Oilfield drilling fluid, often called “mud,” serves multiple purposes in the industry. Among its many functions, the drilling mud acts as a lubricant to cool rotary drill bits and facilitate faster cutting rates. Typically, the mud is mixed at the surface and pumped downhole at high pressure to the drill bit through a bore of the drillstring. Once the mud reaches the drill bit, it exits through various nozzles and ports where it lubricates and cools the drill bit. After exiting through the nozzles, the “spent” fluid returns to the surface through an annulus formed between the drillstring and the drilled wellbore.

Furthermore, drilling mud provides a column of hydrostatic pressure, or head, to prevent “blow out” of the well being drilled. This hydrostatic pressure offsets formation pressures, thereby preventing fluids from blowing out if pressurized deposits in the formation are breeched. Two factors contributing to the hydrostatic pressure of the drilling mud column are the height (or depth) of the column (i.e., the vertical distance from the surface to the bottom of the wellbore) itself and the density (or its inverse, specific gravity) of the fluid used. Depending on the type and construction of the formation to be drilled, various weighting and lubrication agents are mixed into the drilling mud to obtain the right mixture. Typically, drilling mud weight is reported in “pounds,” short for pounds per gallon. Generally, increasing the amount of weighting agent solute dissolved in the mud base will create a heavier drilling mud. Drilling mud that is too light may not protect the formation from blow outs, and drilling mud that is too heavy may over invade the formation. Therefore, much time and consideration is spent to ensure the mud mixture is optimal. Because the mud evaluation and mixture process is time consuming and expensive, drillers and service companies prefer to reclaim the returned drilling mud and recycle it for continued use.

Another significant purpose of the drilling mud is to carry the cuttings away from the drill bit at the bottom of the borehole to the surface. As a drill bit pulverizes or scrapes the rock formation at the bottom of the borehole, small pieces of solid material are left behind. The drilling fluid exiting the nozzles at the bit acts to stir-up and carry the solid particles of rock and formation to the surface within the annulus between the drillstring and the borehole. Therefore, the fluid exiting the borehole from the annulus is a slurry of formation cuttings in drilling mud. Before the mud can be recycled and re-pumped down through nozzles of the drill bit, the cutting particulates must be removed.

Apparatus in use today to remove cuttings and other solid particulates from drilling fluid are commonly referred to in the industry as “shale shakers.” A shale shaker, also known as a vibratory separator, is a vibrating sieve-like table upon which returning solids laden drilling fluid is deposited and through which clean drilling fluid emerges. Typically, the shale shaker is an angled table with a generally perforated filter screen bottom. Returning drilling fluid is deposited at the feed end of the shale shaker. As the drilling fluid travels down the length of the vibrating table, the fluid falls through the perforations to a reservoir below leaving the solid particulate material behind. The vibrating action of the shale shaker table conveys solid particles left behind until they fall off the discharge end of the shaker table. The above described apparatus is illustrative of one type of shale shaker known to those of ordinary skill in the art. In alternate shale shakers, the top edge of the shaker may be relatively closer to the ground than the lower end. In such shale shakers, the angle of inclination may require the movement of particulates in a generally upward direction. In still other shale shakers, the table may not be angled, thus the vibrating action of the shaker alone may enable particle/fluid separation. Regardless, table inclination and/or design variations of existing shale shakers should not be considered a limitation of the present disclosure.

Preferably, the amount of vibration and the angle of inclination of the shale shaker table are adjustable to accommodate various drilling fluid flow rates and particulate percentages in the drilling fluid. After the fluid passes through the perforated bottom of the shale shaker, it can either return to service in the borehole immediately, be stored for measurement and evaluation, or pass through an additional piece of equipment (e.g., a drying shaker, centrifuge, or a smaller sized shale shaker) to further remove smaller cuttings.

Currently, when a drilling operator chooses a separatory profile, therein selecting a type of motion that actuators of the vibratory separator will provide to the screen assemblies, they typically choose between a profile that either processes drilling material quickly or thoroughly. By increasing the speed of conveyance, linear motion vibratory shakers provide increased shaker fluid capacity and increased processing volume. However, in certain separatory operations, the weight of solids may still restrict the speed that linear motion separation provides. Additionally, while increased G-forces enable faster conveyance, as the speed of conveyance increases, there is a potential that the produced drilled solids may still be saturated in drilling fluid.

Alternatively, a drilling operator may select a vibratory profile that imparts lower force vibrations onto the drilling material, thereby resulting in drier cuttings and increased drilling fluid recovery. However, such lower force vibrations generally slow drilling material processing, thereby increasing the time and cost associated with processing drilling material.

Accordingly, there exists a need for a vibratory shaker that produces drier cuttings and increases drilling fluid recovery while increasing processing time.

### SUMMARY OF THE DISCLOSURE

In one aspect, embodiments disclosed herein relate to a vibratory separator including a first actuator coupled to a basket and a second actuator coupled to the basket. Additionally, the vibratory separator includes a motion control switch operatively connected to at least one of the first and second actuators and configured to modulate motion generated by the first and second actuators between a first elliptical motion and a second elliptical motion.

In another aspect, embodiments disclosed herein relate to a method of processing drilling waste, the method including flowing drilling waste over a screen of a vibratory separator and imparting a first elliptical motion to the screen. The method further includes monitoring the flow of drilling waste over the screen, determining an overload condition exists, and adjusting the motion to a second elliptical motion based on the determined load condition.

Other aspects and advantages of the invention will be apparent from the following description and the appended claims.

### BRIEF DESCRIPTION OF DRAWINGS

FIG. 1 is an isometric view of a vibratory separator in accordance with an embodiment of the present disclosure.

FIG. 2 is a top view of a vibratory separator in accordance with an embodiment of the present disclosure.

FIG. 3 is a side view of a vibratory separator in accordance with an embodiment of the present disclosure.

FIG. 4A is a front view of a vibratory separator in accordance with an embodiment of the present disclosure.

FIGS. 4B is a schematic view of rotational motion produced in accordance with an embodiment of the present disclosure.

FIG. 5 is a schematic view of actuators imparting a substantially balanced elliptical motion in accordance with an embodiment of the present disclosure.

FIG. 6 is a schematic view of a resultant motion in accordance with an embodiment of the present disclosure.

FIGS. 7A and 7B are schematic views of a motion control switch in accordance with an embodiment of the present disclosure.

FIGS. 7C and 7D are isometric views of swing weights in accordance with embodiments of the present disclosure.

FIG. 7D is a close perspective view of an actuator in accordance with an embodiment of the present disclosure.

FIG. 7E is a side view of a vibratory separator in accordance with an embodiment of the present disclosure.

FIG. 7F and 7G are isometric views of swings weights in accordance with embodiments of the present disclosure.

FIG. 8 is a schematic view of actuators imparting a progressive elliptical motion in accordance with an embodiment of the present disclosure.

FIG. 9 is a schematic view of a resultant motion in accordance with an embodiment of the present disclosure.

### DETAILED DESCRIPTION

Generally, embodiments disclosed herein relate to apparatuses and methods for separating solids from liquids. Specifically, embodiments disclosed herein relate to apparatuses and methods for separating solids from liquids using dual motion profiles on vibratory separators. More specifically still, embodiments disclosed herein relate to apparatuses and methods for producing a first elliptical motion and a second elliptical motion on vibratory separators.

Traditionally, vibratory separators have been designed to produce a specific type of motion, for example, linear, circular, unbalanced elliptical, or balanced elliptical. The type of motion was dictated by the placement of actuators relative to the vibratory separator body, and as such, the shape of the motion could only be changed by physically altering the configuration/placement of the actuators. Typically, vibratory separators capable of generating a single type of motion use one or two motors positioned at a specific location on the shaker body. For example, round motion may be generated by a single actuator located proximate the center of gravity of the vibratory separator. Linear motion may be generated through the use of two counter rotated actuators disposed on the vibratory separator. Multi-direction elliptical motion may be generated with one actuator disposed a select distance from the center of gravity of the vibratory separator.

More recently, complex motion types, such as balanced elliptical motion, have been employed through the use of two counter rotated motors disposed on the vibratory separator. Furthermore, certain vibratory separators are now designed to allow for the switching of motion types, such as the switching between linear and balanced elliptical motion. Such dual motion vibratory separators typically use three or more motors, wherein two motors are used to produce a first motion type, while the additional motor or motors are only used to switch to a third motion type. In alternate designs, dual motion separators have been designed using two motors, wherein a physical alternation of the placement of one of the motors allows for a change in the motion type or shape.

Embodiments of the present disclosure allow for a two-actuator separator to generate at least two motion types, such as a substantially balanced elliptical motion and an unbalanced, or progressive, elliptical motion. Substantially balanced elliptical motion, as used herein, refers to an elliptical motion that remains substantially constant across a screen, so that cuttings processed at a feed end of a separator are exposed to substantially the same motion type as cuttings processed at a discharge end of the separator. Those of ordinary skill in the art will appreciate that a substantially balanced elliptical motion may further refer to a motion shape that has an aspect ratio that varies less than 30% throughout the length of the vibratory separator. In certain aspects, substantially balanced elliptical motion may refer to a motion shape that has an aspect ratio that varies less than 20% or less than 10% throughout the length of the vibratory separator. Those of ordinary skill in the art will further appreciate that modulating the type of motion depending on operational parameters of the drilling operations, such as drill cutting flow rate, may allow for a more efficient processing of drilled solids. Balanced elliptical motion allows for a relatively fast processing of drilled solids while preserving screen life compared to linear motion of equal acceleration. In contrast, progressive elliptical motion allows for cuttings to be quickly transferred off of a feed end of a vibratory separator, while allowing the cuttings to be retained at a discharge end longer, thereby resulting in relatively drier cuttings. In certain embodiments, a first elliptical motion, such as a balanced elliptical motion, may have a relatively high aspect ratio that results in relatively fast cuttings transferences, while a second elliptical motion, such as a progressive elliptical motion, may have a relatively low aspect ratio that results in relatively slow cuttings transference. Those of ordinary skill in the art will appreciate that generally, the wider the aspect ratio of the ellipse, the slower cuttings are discharged from the vibratory separator. For example, ellipse aspect ratios of greater than 3/1 may generally result in fast cuttings transference, while ellipse aspect ratios of less than 3/1 may result in relatively slow cuttings transference. While specific embodiments of the present disclosure will be discussed in detail below, generally, embodiments disclosed herein may allow for the modulation between motion types and or shapes by changing the operational parameters of a vibratory separator.

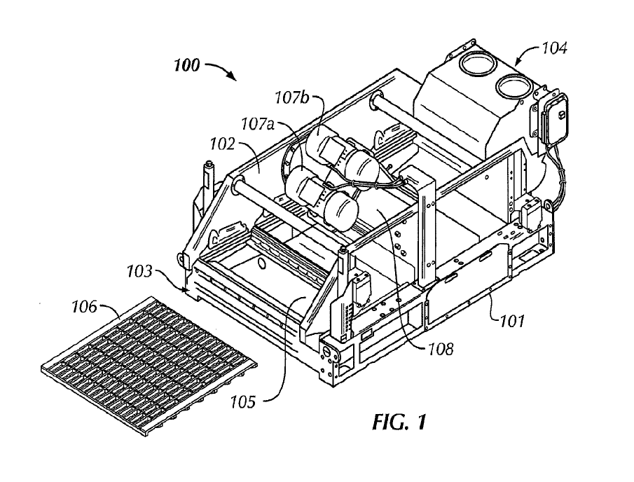

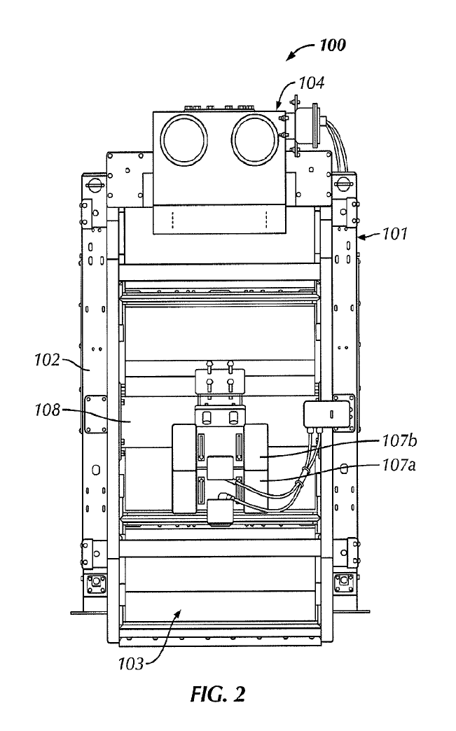

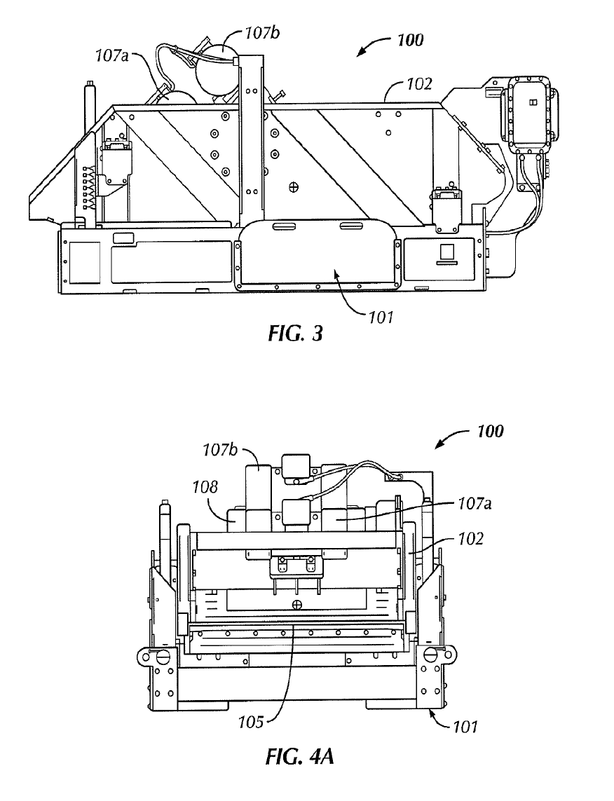

Referring initially to FIGS. 1-4A, isometric, top, side and front views of a vibratory separator 100 in accordance with an embodiment of the present disclosure are shown. In this embodiment, vibratory separator 100 includes a frame 101, side walls 102, a discharge end 103, and an inlet end 104. Vibratory separator 100 also includes a basket 105 that holds a screen assembly 106. Operationally, as drilling material enters vibratory separator 100 through inlet end 104, the drilling material is moved along screen assembly 106 by a vibratory motion. As screen assembly 106 vibrates, residual drilling fluid and particulate matter may fall through screen assembly 106 for collection and recycling, while larger solids are discharged from discharge end 103.

In one embodiment, vibratory motion is supplied by a plurality of actuators 107a and 107b coupled to a support member 108 for imparting the vibratory motion to basket 105. Actuators 107 are driven by rotary motors (not shown) having shafts (not shown) coupled to identical unbalanced weights (not shown) attached to opposite ends of the shafts. Those of ordinary skill in the art will appreciate that the weights may be substantially identical on each individual motor, while the weights may not be identical on separate motors.

A motion control switch (not independently illustrated) is also operatively connected to actuators 107 to allow for the switching between a plurality of motion types and shapes. In one embodiment, motion control switch may include a mechanical switch to allow an operator to select between at least two modes of operation, for example, to select between a progressive elliptical motion and a balanced elliptical motion. In other embodiments, the motion control switch may include a user interface, such as a digital control interface, to allow an operator to select between motion types, shapes, or control specific operational parameters, such as, for example, actuator force output or actuator speed. In certain embodiments, vibratory separator 100 may include multiple motion control switches operatively connected to one or more of actuators 107, thereby allowing for the switches to be modulated individually or together to allow for the switching between a plurality of motion types and shapes.

In certain embodiments the rotary motors may be operatively connected to a programmable logic controller (“PLC”) (not shown) that may supply instructions to actuators 107 or other components of vibratory separator 100. The instructions to actuators 107 may include vibratory motion protocols that define a pattern of movement for moving basket 105. In other embodiments, the motion control switch and/or PLC may include instructions to modulate a power signal to at least one of actuators 107a and 107b. By changing the power signal, actuators 107a and 107b may operate at a selected speed, thereby changing the resultant acceleration of the motion.

While both actuators 107a or 107b operate at the same speed, embodiments disclosed herein include actuators 107a and 107b that have eccentric weights that swing in different directions depending on whether the rotation of the weights are in a forward direction or a reversed direction. Thus, by modulating the rotation of the weights from a forward direction to a reverse direction, the shape of the motion imparted to basket 105 may be changed. Those of ordinary skill in the art will appreciate that design parameters of vibratory separators that may change a resultant motion produced include the force ratio of each actuator, the distance between the actuators, the angle of a platform relative to the screens, mass and inertia properties of the baskets, the angle of a mounting surface relative to the basket, and the placement of the actuators relative to the center of gravity of the separator.

PLCs may be used to control the resultant motion by, for example, instructing a variable frequency drive to slow or reverse the direction of rotation of the eccentric weights of one or more of actuators 107a and 107b. In other embodiments, the operation of actuators 107a and/or 107b may be controlled directly through a vibratory separator control system. Those of ordinary skill in the art will appreciate that PLCs are not a requirement for all applications, and as such, actuators may be independently controllable with or without a PLC. In certain embodiments, the motion control switch may send instructions though a PLC, or a motion control switch and a PLC may function together as part of a user interface.

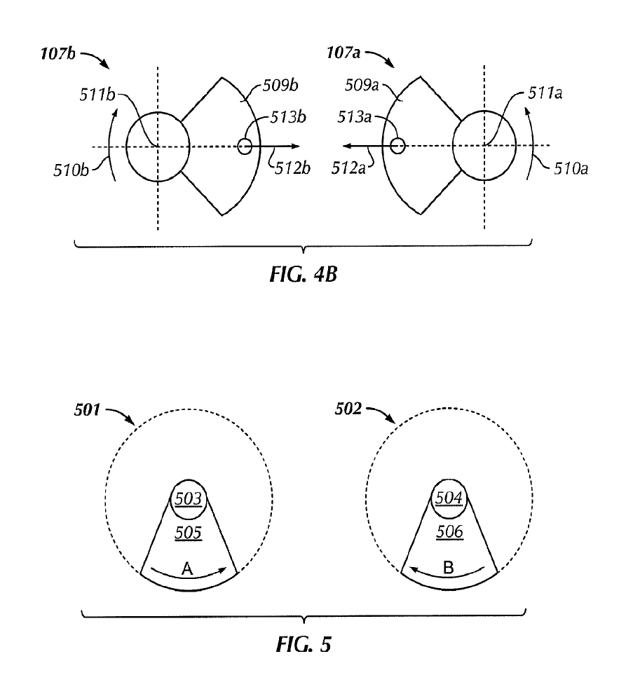

Referring now to FIG. 4B, a schematic view of a rotational motion of actuators during operation of a vibratory separator in accordance with one embodiment of the present disclosure is shown. In this embodiment, the instructions from the PLC to the motors may define a pattern of movement that constitutes a desired motion type. In such an embodiment, the motors may drive actuators 107a and 107b thereby rotating unbalanced weights 509b and 509a in opposite directions 510b and 510a around their respective axes of rotation 511b and 511a. The rotation of unbalanced weights 509b and 509a produces centrifugal forces 512b and 512a as the centers of mass 513b and 513a rotate in equal planes relative to their respective axes of rotation 511b and 511a.

Referring to FIG. 5, a schematic view of actuators imparting a balanced elliptical motion, according to embodiments of the present disclosure, is shown. In this embodiment, a first actuator 501 and a second actuator 502 are illustrated, wherein each actuator 501 and 502 have respective shafts 503 and 504 upon which unbalanced weights 505 and 506 rotate. As illustrated, actuators 501 and 502 are configured such that unbalanced weights 505 and 506 rotate as represented by directional arrows A and B. During such rotation, unbalanced weight 505 rotates in direction A, while unbalanced weight 506 rotates in direction B. Unbalanced weights 505 and 506 may or may not be equal weights, and as such, may include different sizes, depending on the particular type of motion being generated.

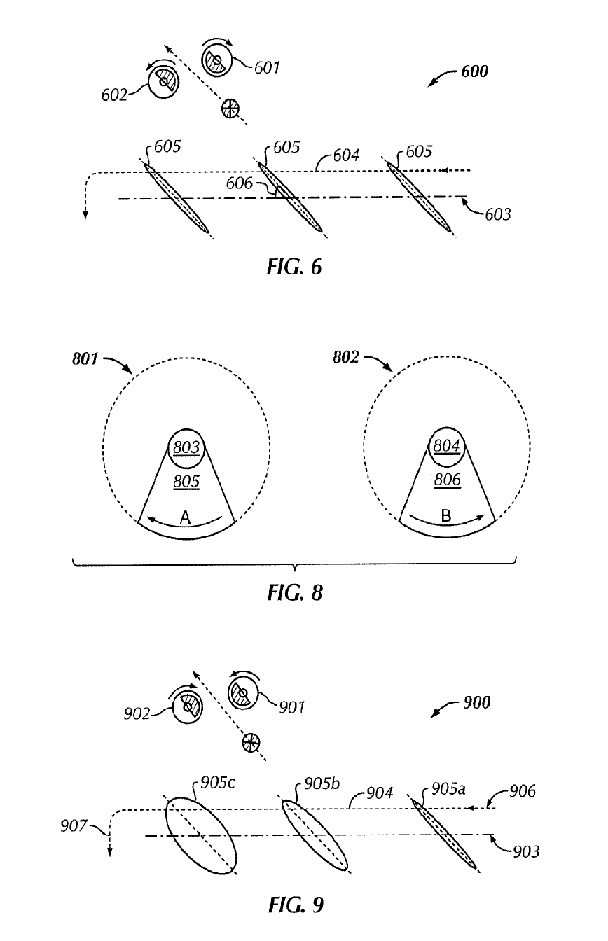

Referring to FIG. 6, a schematic view of a resultant motion of a vibratory separator 600 according to embodiments of the present disclosure is shown. In this embodiment, actuators 601 and 602, similar to actuators 501 and 502 of FIG. 5, are shown. In this embodiment, vibratory separator 600 includes a screening deck 603 and a flow of drilled solids 604 passing thereacross. The rotation of unbalanced weights (not illustrated) of actuators 601 and 602 rotating generates a thin-ellipse shaped resultant motion 605, which is substantially similar along the length of screening deck 603. In this embodiment, the force output of actuator 601 is larger than the force output of actuator 602. For example, the force output of actuator 601 may be in a range between 1.0 and 1.5 times the force output of actuator 602. In certain embodiments, the force output of actuator 601 may be, for example, 1.2 times the force output of actuator 602.

As illustrated, the angle of acceleration (shown as reference character 606) of the motion is approximately 45° relative to screen deck 603. A 45° angle of acceleration 606 may allow for an optimal transference of drilled solids across screen deck 603 by providing adequate energy to separate liquid phase from the solids phase, while also transferring the drilled solids across screen deck 603 efficiently. However, in alternate embodiments, angle of acceleration 606 may vary between for example 30° and 60° , and in certain embodiments may be greater than 60° or less than 30°. Those of ordinary skill in the art will appreciate that the angle of acceleration 606 and the aspect ratio of the resultant ellipse may be varied to optimize the resultant balanced elliptical motion.

In this embodiment, the thin-ellipse has a relatively longer major axis to minor axis, and as such, those of ordinary skill in the art will appreciate that balanced elliptical motion may allow for a relatively fast transference of drilled solids across screen deck 603. Accordingly, balanced elliptical motion may be beneficial to use when the drilling operation is producing a high flow rate of drilled solids to vibratory separator 600. Additionally, in contrast to other types of motion, such as linear motion, balanced elliptical motion may result in longer screen life. Unlike linear motion, which results in a full stop at each end of the stroke, elliptical motion is continuous, thereby reducing the impact by the material against the screen. Finally, balanced elliptical motion results in a tumbling of drilled solids across the screens, thereby providing increased separation of liquid phase from solid phase.

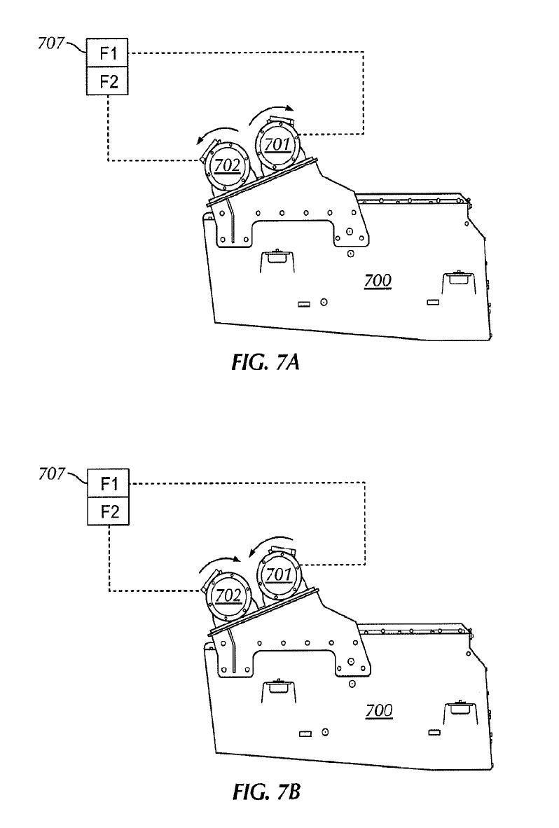

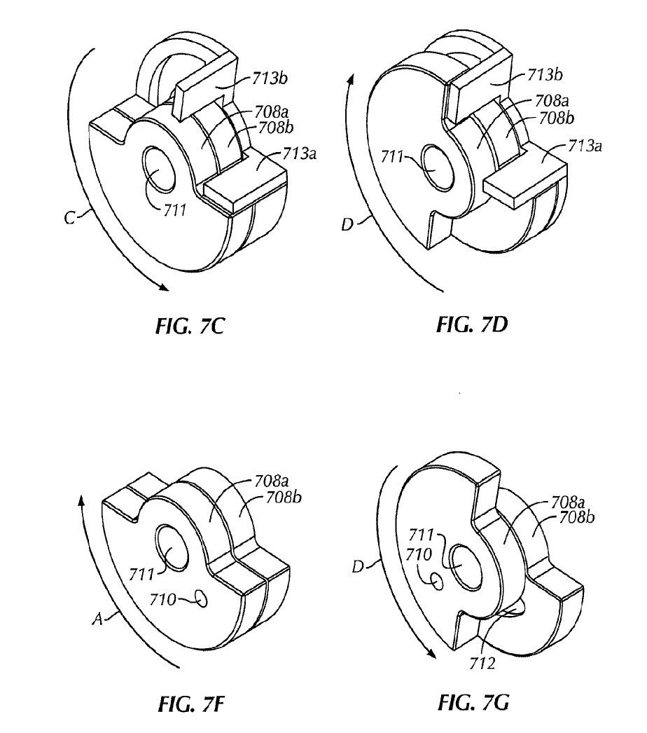

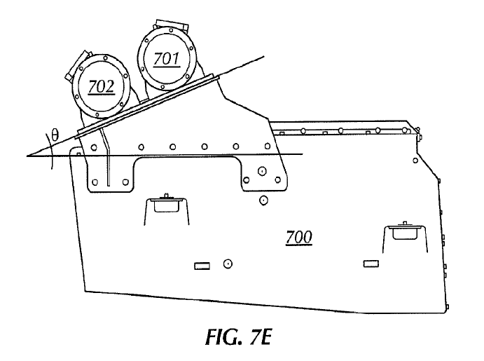

Referring to FIGS. 7A and 7B together, schematic illustrations of a motion control switch 707 according to embodiments of the present disclosure are shown. In a first embodiment represented at FIG. 7A, actuators 701 and 702 are operatively coupled to motion control switch 707. Motion control switch 707 is configured to control the type of motion generated by actuators, and as such, may contain software instructions or control logic for operating actuators 701 and/or 702 to produce a desired force output and therefore a desired type of motion. Those of ordinary skill in the art will appreciate that modifying other design parameters of vibratory separators may also change the type of motion generated. In this embodiment, motion control switch 707 is configured to modulate the force output of actuators 701 and 702, and also control the direction of rotation of unbalanced weights. FIG. 7A illustrates a configuration of actuators 701 and 702 and motion control switch 707 that generates balanced elliptical motion, as described above. In this embodiment, motion control switch 707 provides instructions to actuators 701 and 702 instructing actuators 701 and 702 to rotate as illustrated. Additionally, motion control switch 707 provides instructions to control the force output of actuators 701 and 702, which in this embodiment, includes instructions for 100% force output from each motor. However, in alternate embodiments, the force output may be kept relatively equal.

As illustrated, F1 defines the force output of actuator 701, while F2 defines the force output of actuator 702. In this embodiment, the force output of actuator 701 is larger than the force output of actuator 702. For example, the force output of actuator 701 may be in a range between 1.0 and 1.5 times the force output of actuator 702. In certain embodiments, the force output of actuator 701 may be, for example, 1.2 times the force output of actuator 702. Those of ordinary skill in the art will appreciate that a particular range of force ratios may vary based on a desired motion shape and/or other design parameters, such as, for example, the location of actuators 701 and 702 relative to the center of gravity of a vibratory separator 700, the spacing between actuators 701 and 702, the angle formed between an actuator mounting surface and the basket of vibratory separator 700, mass and inertia properties of vibratory separator 700, and a rotational speed of one or more of actuators 701 and 702. Referring briefly to FIG. 7E, a side view of a vibratory separator 700 according to embodiments of the present disclosure is shown. As illustrated, actuators 701 and 702 are mounted on vibratory separator 700 at a particular mounting angle Θ. Mounting angle Θ may vary depending on the mounting location of actuators 701 and 702 relative to a top screen surface of vibratory separator 700. By adjusting mounting angle Θ, a motion shape of vibratory separator 700 may be varied, so as to optimize a particular motion shape used in the processing of drill cuttings. In certain embodiments, mounting angle Θ may range between substantially 0° to about 45°, while in other embodiments, mounting angle Θ may range between about 10° and about 30°.

Referring back to FIG. 7A, motion control switch 707 may be an independent component of a vibratory separator, such as a PLC, as discussed above. In such an embodiment, an operator may selectively control the operation of the vibratory separator by, for example, turning a physical switch or programming new instructions into a digital user interface. In other embodiments, motion control switch 707 may include a component of a vibratory separator operation system, and as such, may include hardware and/or software components. Accordingly, in certain embodiments, selecting an operation mode for a vibratory separator may include use of a motion control switch to instruct the actuators independently or through the use of a vibrator control system to generate a specific type of motion. In this embodiment, an operator may program a vibratory separator to generate balanced elliptical motion (or progressive elliptical motion), or alternatively, an operator may program a vibratory separator to operate in a high gravity-force mode or a screen life mode. In still other embodiments, motion control switch 707 may operate as part of an automated control system to determine changes in the flow rate of cuttings into the separator, thereby automatically adjusting the motion type generated.

FIG. 7B illustrates a second mode of operation for a vibratory separator, in which the operations of actuators 701 and 702 have been modified by motion control switch 707. In this embodiment, motion control switch 707 instructed actuators 701 and 702 to reverse the direction of rotation of unbalanced weights 708 of actuators 701 and 702. As such, the rotation of unbalanced weights 708 results in a progressive elliptical motion. While progressive elliptical motion will be explained in detail below, those of ordinary skill in the art will appreciate that switching between substantially balanced elliptical motion and progressive elliptical motion may allow an operator to adjust the type of motion generated by a vibratory separator to match a condition of the drilling operation. As such, the efficiency of the operation may be increased without increasing the number of physical components at a drilling location.

As illustrated, F1 defines the force output of actuator 701, while F2 defines the force output of actuator 702. In this embodiment, the force output of actuator 701 is larger than the force output of actuator 702. For example, the force output of actuator 701 may be in a range between 1.5 and 2.0 times the force output of actuator 702. In certain embodiments, the force output of actuator 701 may be, for example, 1.66 times the force output of actuator 702. Those of ordinary skill in the art will appreciate that a particular range of force ratios may vary based on a desired motion shape and/or other design parameters, such as, for example, the location of actuators 701 and 702 relative to the center of gravity of a vibratory separator 700, the spacing between actuators 701 and 702, the angle formed between an actuator mounting surface and the basket of vibratory separator 700, mass and inertia properties of vibratory separator 700, and a rotational speed of one or more of actuators 701 and 702.

Referring to FIGS. 7C and 7D, isometric views of swing weights according to embodiments of the present disclose are shown. FIG. 7C illustrates swing weights including an inner weight 708B and an outer weight 708A. In this embodiment, outer weight 708A is fixed to actuator shaft 711, while arcuate member 714 is attached to inner weight 708B. Arcuate member 714 include two stops 713A and 713B, which are configured to contact inner and outer weights 708B and 708A during operation. During operation, as outer weight 708A is rotated counter-clockwise, in direction C, outer weight 708A contacts stop 713A. As stop arcuate member 714 is attached to inner weight 708B, the contact of outer weight 708A with stop 713A causes inner weight 708B to be driven with outer weight 708A in direction C. Such a configuration results in a relatively high unbalance, which may be used to generate a substantially balanced elliptical motion.

Referring to FIG. 7D, swing weights include an inner weight 708B and an outer weight 708A. In this embodiment, outer weight 708A is rotated on actuator shaft 711 clockwise, in direction D. As outer weight 708A rotates, it contacts stop 713B, which drives inner weight 708B with outer weight 708A in direction D. Such a configuration results in a relative low unbalance value, and may be used to generate a progressive elliptical motion.

Referring back to 7B, actuators 701 and 702 may be rotated toward each other while producing a relatively out-of-balance force output ratio, thereby resulting in a progressive elliptical motion. In contrast, referring back to FIG. 7A, actuators 701 and 702 may be rotated away from each producing a relatively similar force output ratio, thereby resulting in a balanced elliptical motion.

Referring to FIGS. 7F and 7G, isometric views of swing weights according to embodiments of the present disclose are shown. Referring initially to FIG. 7F, a first position of swing weights 708A and 708B are shown. In this embodiment, inside weight 708B is fixed to an actuator shaft 711 of the actuator, while outside weight 708A is free to rotate. As illustrated, swings weights 708A and 708B are shown with 100% unbalance, or a relatively high unbalance, which may be used to provide a motion type illustrated in FIG. 6, and schematically illustrated in FIG. 7A. In this embodiment, a pin 710 that is disposed on outside weight 708A fits into a slot (not shown) of inside weight 708B. When inside weight rotates clockwise, in direction A, pin 710 bottoms out in the right side of the slot of inner weight 708B, thereby causing a relatively high unbalance. Referring to FIG. 7G, a second position of swing weights 708A and 708B is shown. In the second configuration, swing weights 708A and 708B as illustrated wherein inside weight 708B includes a slot 712, while outside weight 708A includes a pin 710. When rotating the inside weight counter-clockwise, indicated as direction B, pin 710 of outer weight 708A bottoms out in the left side of slot 712 of inner weight 708B, thereby causing a relatively low unbalance. Such a configuration may be used to provide a progressive elliptical motion shape, such as the shape that is described in greater detail in FIG. 9, below.

By adjusting the relative positions of swing weights 708A and 708B, the type of motion produced may be varied. For example, in certain embodiments, a resulting acceleration of the first elliptical motion may be less than a resulting acceleration of the second elliptical motion. In particular embodiments, the resulting acceleration of the first elliptical motion may be in a range of about 60% to about 95% of the acceleration of the second elliptical motion. In other embodiments, a resulting displacement of the first elliptical motion may be less than a resulting displacement of the second elliptical motion. In such an embodiment, the first and second elliptical motion profiles may have a substantially similar shape, with a different stroke length, which may thereby result in different conveyance speeds. Such an embodiment may thereby adjust the motion profiles while maintaining a substantially constant acceleration for both profiles. In particular embodiments, the resulting displacement of the first elliptical motion may be in a range of about 10% to about 95% of the displacement of the second elliptical motion. In such an embodiment, the motion may be modulated by changing a rotational speed of one or more of the first and second actuators. Additionally, to modulate a force output of one or more of the first and second actuators, at least one of the first and second actuators may include a swing weight, as described above.

Referring to FIG. 8, a schematic view of actuators imparting a progressive elliptical motion, according to embodiments of the present disclosure is shown. In this embodiment, a first actuator 801 and a second actuator 802 are illustrated, wherein each actuator 801 and 802 have respective shafts 803 and 804 upon which unbalanced weights 805 and 806 rotate. As illustrated, actuators 801 and 802 are configured such that unbalanced weights 805 and 806 rotate as represented by directional arrows A and B. During such rotation, unbalanced weight 805 rotates in direction A, while unbalanced weight 806 rotates in direction B.

Referring to FIG. 9, a schematic view of a resultant motion to a vibratory separator 900 according to embodiments of the present disclosure is shown. In this embodiment, vibratory separator 900 includes a screening deck 903 and a flow of drilled solids 904 passing thereacross from a feed end 906 to a discharge end 907. The rotation of unbalanced weights (not illustrated) of actuators 901 and 902 rotating generates a resultant motion 905 that varies across screening deck 903. In this embodiment, the force output of actuator 901 is larger than the force output of actuator 902. For example, the force output of actuator 901 may be in a range between 1.5 and 2.0 times the force output of actuator 902. In certain embodiments, the force output of actuator 901 may be, for example, 1.66 times the force output of actuator 902.

Progressive elliptical motion includes the formation of different aspect ratio ellipses along the length of screening deck 903. For example, in this embodiment, resultant motion 905A at feed end 906 includes a relatively thin ellipse having a longer major axis relative to a minor axis. Resultant motion 905A may thereby result in an ellipse similar to that typically produced during balanced elliptical motion, as described above. As drilled solids flow across screening deck 903, the aspect ratio of the ellipse of the resultant motion 905 changes. For example, resultant motion 905B includes a relatively wider ellipse. Still further, as drilled solids progress across screening deck 903 toward discharge end 907, resultant motion 905C may approximate round or circular motion. Resultant motion 905C may thereby cause drilled solids to tumble more slowly than motion 905B. Accordingly, drilled solids may be retained on screening deck 903 for a longer period of time, thereby resulting in drier discharged cuttings.

Those of ordinary skill in the art will appreciate that progressive elliptical motion may provide the benefits of both round and linear motion. For example, the thin aspect ellipse (i.e., high aspect ellipse) at feed end 906 may increase the speed at which drilled solids are transferred across screening decking 903. However, as the drilled solids progress across screening deck 903, the wider aspect ellipses (i.e., low aspect ellipse) slow the progression of the drilled solids, such that drilled solids may be retained on the screening deck 903 longer. By increasing the time the drilled solids remain on screening deck 903, relatively drier drilled solids may be produced.

Progressive elliptical motion may thereby provide ellipses of different aspect ratios across the screen of a vibratory separator. For example, in one embodiment, a progressive elliptical motion may result in an aspect ratio that decreases when moving from a feed end of the vibratory separator to a discharge end of the vibratory separator. In certain embodiments, the aspect ratio of the progressive elliptical motion may decrease about 30% or greater from the feed end to the discharge end. In other embodiments, the aspect ratio of the progressive elliptical motion may decrease between 50% to over 1000% from the feed end to the discharge end. In other embodiments, a progressive elliptical motion may result in an aspect ratio that decreases when moving from the discharge end to the feed end. In such an embodiment, the aspect ration of the progressive elliptical motion may decrease about 30% or greater from the discharge end to the feed end. In other embodiments, the aspect ratio of the progressive elliptical motion may decrease between 50% to over 1000% from the he discharge end to the feed end. Depending on the particular location on the screen of a vibratory separator, the aspect ratio of an ellipse may range between 1.5 and 20.0. Thus, an aspect ratio of an ellipse or a progression of ellipses across the screen of a vibratory separator may be varied to balance the requirements to produce dry cuttings while maintaining a desired processing speed.

Those of ordinary skill in the art will appreciate that in alternate embodiments, additional actuators may be used to impart additional motion types to the basket and/or the frame of the separator. For example, a third actuator may be operatively coupled to the motion control switch, thereby allowing additional vibratory motions to be generated. In still other embodiments, additional components, such as sensors, control units, and reluctance motors, may be used to change aspects of vibratory separator operation. For example, in certain embodiments, reluctance motors may be used to synchronize the motion of the actuators during balanced elliptical motion, sensors may be used to measure the resultant motion being produced, and control units may be used to vary operational parameters, such as actuator force output. Additionally, referring briefly back to FIG. 7C, bearings 158 disposed within actuator 107 may be cylindrical rather than spherical. In the present disclosure, two actuators 107 are disposed on horizontal shafts, configured to transmit vibratory motion to a basket of the vibratory separatior. Additionally, dual actuators 107 are configured to produce both a balanced elliptical and progressive elliptical motion. By including cylindrical bearings instead of spherical bearings, actuators 107 arranged on horizontal shafts (as illustrated in FIGS. 1-4A), may advantageously withstand operational conditions, thereby extending the life of actuators 107, and/or decreasing the amount of maintenance on actuators 107. Additionally, vibratory separators having dual actuators 107 disposed on horizontal shafts configured to produce only a balanced elliptical or progressive elliptical motion may benefit from the present disclosure. Furthermore, other dual motion drive configurations (e.g., actuators that produce both linear and balanced elliptical or both linear and progressive elliptical) may benefit from the use of cylindrical bearings. Moreover, in certain embodiments, actuators 107 used to produce balanced elliptical and/or progressive elliptical motion may not include swinging weights, as discussed above with respect to the present disclosure. In such actuators 107 not using swinging weights, cylindrical bearings may also be used instead of spherical bearings to further increase the integrity of actuator 107. Thus, those of ordinary skill in the art will appreciate that actuators 107 used to produce vibratory motion for vibratory separators may benefit from the use of cylindrical bearings in accordance with the embodiments discussed herein.

During operation, a drilling operator may provide a flow of drilling waste, including drilled solids, over a screen of a vibratory separator. Initially, a specific motion may be imparted to a screening deck, and thus the screen, of the vibratory separator. In one embodiment, the initial motion may include a progressive elliptical motion. As the vibratory separator imparts the motion to the screen, and thus moves drilled solids thereacross, the flow of drilling waste of the screens may be monitored. In one embodiment, the monitoring of the drilling waste may include visual inspection of the progression of the drilled solids across the screens, while in other embodiments, sensors on the vibratory separator may monitor the rate of drilling fluid flow into the vibratory separator. Examples of sensors may include ultra sonic sensors and/or other sensors that measure the depth of a fluid pond of a vibratory separator. In still other embodiments, the mass of drilling waste on the vibratory separator may be determined using sensors, thereby allowing the vibratory separator or an operator to determine when an overload condition occurs.

An overload condition may be a predetermined flow rate of drilling waste into vibratory separator, or alternatively, may be a specific mass of drilling waste on the screen deck. In still other embodiments, an overload condition may occur if one side of the vibratory separator, such as a discharge or feed end, has a mass of drilling waste that is too high for efficient processing. After an overload condition is determined, the motion of the vibratory separator may be adjusted to, for example, a balanced elliptical motion, such that drilling waste is moved across the screening deck more quickly. By varying a type of motion produced by a vibratory separator between a progressive elliptical and balanced elliptical motion, the benefits of enhanced drying provided by progressive elliptical and the benefits of faster processing speeds of balanced elliptical motion may be achieved without the need for modifying the physical structure of vibratory separator components.

In addition to determining an overload condition, an operator or the vibratory separator may be configured to determine when a normal condition occurs. A normal condition may include a predetermined drilled solids flow rate, or alternatively, a predefined mass of drilling waste on the screening deck. When a normal condition is determined, a vibratory separator operating to generate balanced elliptical motion may be adjusted to generate progressive elliptical motion. Thus, upon actuation by an operator, or through automation, vibratory separators according to embodiments disclosed herein may provide for the adjustment of motion types of match a specific drilling and/or or waste return conditions.

In still other embodiments, operation of a vibratory separator according to embodiments disclosed herein may include adjustment of a motion between specific modes of operation. For example, in one embodiment, a vibratory separator may be programmed to operate in an efficiency mode and a high acceleration mode. As discussed above, an efficiency mode may include operation using an progressive elliptical motion, while a high acceleration mode may include operation using a balanced elliptical motion. Such operational modes may thereby allow an operator or the vibratory separator through automation to determine if the flow or mass of drilling waste requires adjustment of the operation mode. If adjustment of the operation mode, for example from an efficiency mode, is desired, then an operator or the vibratory separator may adjust the motion to, for example, a high acceleration profile.

While the above embodiments have been described relative to switching between two motion profiles, specifically, between a balanced elliptical motion and a progressive elliptical motion, those of ordinary skill in the art will appreciate that multiple sub- profiles, including balanced or progressive elliptical motion types, may also be selected. For example, a vibratory separator may be configured to produce multiple aspect ratio ellipses during a single mode of operation. In one embodiment, a vibratory separator may be configured to produce a balanced elliptical motion with multiple angles of acceleration (e.g., 45°, 50°, and 55°. Thus, an operator may also be able to choose between the angle of acceleration of the balanced elliptical motion. Similarly, a vibratory separator may be configured to produce varied progressive elliptical motion profiles by, for example, changing the force output from one or more of the actuators. In one embodiment, the force output of a first actuator may be relatively larger than the force output of a second actuator, such as the force output of a first actuator being in a range between 1.5 and 2.0 times the force output of a second actuator. By increasing the force output of the second actuator, the resultant motion of the screening deck may be change. In other embodiments, by decreasing the force output of the first actuator, the resultant motion may also be changed. Thus, in addition to allowing selection between a balanced and progressive elliptical motion, embodiments disclosed herein may allow for the selection between sub-motion types by varying the relative force output of one or more of the actuators of the vibratory separator.

For example, depending on the particular requirements of a separatory operation, the motion may be modulated between a first elliptical motion, such as a substantially balanced elliptical motion, and a second elliptical motion, such as a progressive elliptical motion. In other embodiments, by varying, for example, the relative force output of one or more of the actuators, the motion may be modulated between a first elliptical motion, such as a substantially balanced elliptical motion, and a second elliptical motion, such as a second substantially balanced elliptical motion. In still other embodiments, by varying, for example, the relative force output of one or more of the actuators, the motion may be modulated between a first elliptical motion, such as a progressive elliptical motion, and a second elliptical motion, such as a second progressive elliptical motion.

Advantageously, embodiments of the present disclosure may allow for a more efficient processing of drilling waste. Because embodiments disclosed herein allow a single vibratory separator to modulate between balanced elliptical and progressive elliptical motion types, the vibratory separator may process drilling waste with increased efficiency. Furthermore, embodiments disclosed herein may allow for the generation of both balanced elliptical and progressive elliptical motion through the use of two actuators, instead of three or more actuators. By decreasing the number of actuators, stress points on the vibratory separator frame may be decreased, thereby increasing the integrity of the vibratory separator. Additionally, by decreasing components of the vibratory separator, typical maintenance associated with components of the vibratory separator may also be decreased.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. A vibratory separator comprising:
a first actuator coupled to the basket;
a second actuator coupled to the basket; and
a motion control switch operatively connected to at least one of the first and second actuators and configured to modulate motion generated by the first and second actuators between a first elliptical motion and a second elliptical motion.

2. The vibratory separator of claim 1, further comprising:
a third actuator coupled to the basket and operatively connected to the motion control switch.

3. The vibratory separator of claim 1, wherein the motion control switch comprises a programmable logic controller.

4. The vibratory separator of claim 1, wherein a resulting acceleration of the first elliptical motion is less than a resulting acceleration of the second elliptical motion.

5. The vibratory separator of claim 4, wherein the resulting acceleration of the first elliptical motion is in the range of about 60% to about 95% of the acceleration of the second elliptical motion.

6. The vibratory separator of claim 1, wherein at least one of the first and second actuators comprises a swing weight.

7. The vibratory separator of claim 1, wherein a resulting displacement of the first elliptical motion is less than the resulting displacement of the second elliptical motion.

8. The vibratory separator of claim 7, wherein the resulting displacement of the first elliptical motion is in the range of about 10% to about 95% of the displacement of the second elliptical motion.

9. The vibratory separator of claim 7, wherein one or more of the first and second elliptical motions is modulated by changing a rotational speed of one or more of the first and second actuators.

10. The vibratory separator of claim 1, wherein an aspect ratio of the first elliptical motion is substantially different than an aspect ratio of the second elliptical motion.

11. The vibratory separator of claim 10, wherein the aspect ratios are in a range of about 1.5 to about 20.

12. The vibratory separator of claim 1, wherein the first elliptical motion comprises a progressive shape, wherein an aspect ratio of the first elliptical motion decreases across a separator deck from a feed end to a discharge end.

13. The vibratory separator of claim 12, wherein the aspect ratio decreases by 30% or more from the feed end to the discharge end.

14. A method of processing drilling waste, the method comprising:
flowing drilling waste over a screen of a vibratory separator;
imparting a first elliptical motion to the screen;
monitoring the flow of drilling waste over the screen;
determining an overload condition exists; and
adjusting the motion to a second elliptical motion based on the determined load condition.

15. The method of claim 14, further comprising:
repeating the monitoring and determining until a normal condition is determined; and
adjusting the motion to the first elliptical motion based on the determined normal condition.

16. The method of claim 14, wherein an overload condition comprises at least one of a predetermined flow rate of drilling waste into the vibratory separator and a predetermined mass of drilling waste on the screen.

17. The method of claim 14, wherein the normal condition comprises at least one of a predetermined flow rate of drilling waste into the vibratory separator and a predetermined mass of drilling waste on the screen.

18. The method of claim 14, wherein the first elliptical motion comprises a progressive shape from a high aspect ratio ellipse at a feed end to a low aspect ratio ellipse at a discharge end.

19. The method of claim 14, wherein the motion is adjusted by changing a rotational speed of one or more actuators of the vibratory separator.

20. The method of claim 14, wherein the motion is adjusted by changing a displacement of a weight of one or more actuators of the vibratory separator.

21. The method of claim 14, wherein one of the first and second elliptical motions comprises a relatively consistent aspect ratio from a feed end of the vibratory separator to a discharge end of the vibratory separator.

22. The method of claim 21, wherein one of the first and second elliptical motions comprises a progressive shape, wherein the aspect ratio decreases from the feed end of the vibratory separator to the discharge end of the vibratory separator.

23. The method of claim 21, wherein one of the first and second elliptical motions comprises a progressive shape, wherein the aspect ratio decreases from the discharge end of the vibratory separator to the feed end of the vibratory separator.

24. The method of claim 14, wherein the first elliptical motion is generated by operating a first actuator to generate a force output in a range between about 1.0 and 1.5 times a force output of the second actuator.

25. The method of claim 24, wherein the second elliptical motion is generated by operating the first actuator to generate a force output in a range between about 1.5 and 2.0 times a force output of the second actuator.
